(19) United States
(12) Patent Application Publication
(10) Pub. No.: US 2007/0058151 A1
(43) Pub. Date: Mar. 15, 2007

(54) Optical element for use in lithography apparatus and method of conditioning radiation beam

(75) Inventors: Markus Franciscus Antonius Eurlings, Tilburg (NL); Marinus Johannes Maria Van Dam, Venlo (NL); Hendrikus Robertus Marie Van Greevenbroek, Eindhoven (NL); Edwin Wilhelmus Marie Knols, Breda (NL); Heine Melle Mulder, Veldhoven (NL); Gerardus Hubertus Petrus Maria Swinkels, Eindhoven (NL); Damian Fiolka, Oberkochen (DE)

Correspondence Address: PILLSBURY WINTHROP SHAW PITTMAN, LLP, P.O. BOX 10500, MCLEAN, VA, 22102, US

(73) Assignees: ASML Netherlands B.V., Veldhoven (NL); Carl Zeiss SMT AG, Oberkochen (DE)

(21) Appl. No.: 11/224,319

(22) Filed: Sep. 13, 2005

(51) Int. Cl. G03B 27/72

(52) U.S. Cl. 355/71; 355/67

(57) ABSTRACT

An optical element for effecting a desired change in incident radiation at a plane of an illumination system of a lithographic apparatus comprises an array of cells manufactured as a single unit, each cell being arranged to redirect the incident radiation in a predetermined direction. An array of polarizing regions is also provided, each polarizing region being associated with a corresponding cell. Each cell arranged to redirect radiation in a first direction has associated with it a polarizing region ensuring that the redirected radiation has a first polarization, so that all of the radiation redirected in the first direction has the same polarization.

### FIELD OF THE INVENTION

The present invention relates to an optical element for use in a lithographic apparatus and to a method for conditioning a radiation beam in a lithographic apparatus.

### BACKGROUND TO THE INVENTION

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. comprising part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

It is well-known in the art of lithography that the image of a mask pattern can be improved, and process windows enlarged, by appropriate choice of the angles at which the mask pattern is illuminated. In an apparatus having a Koehler illumination arrangement, the angular distribution of radiation illuminating the mask is determined by the intensity distribution in a pupil plane of the illumination system, which can be regarded as a secondary source. Illumination modes are commonly described by reference to the shape of the intensity distribution in the pupil plane. Conventional illumination, i.e. even illumination from all angles from 0 to a certain maximum angle, requires a uniform disk-shaped intensity distribution in the pupil plane. Other commonly-used intensity distributions are: annular, in which the intensity distribution in the pupil plane is an annulus; dipole illumination, in which there are two poles in the pupil plane; and quadrupole illumination, in which there are four poles in the pupil plane. To create these illumination schemes, various methods have been proposed. For example, a zoom-axicon, that is a combination of a zoom lens and an axicon, can be used to create conventional or annular illumination with controllable inner and outer radii (σᵢₙₙₑᵣ and σₒᵤₜₑᵣ) of the annulus. To create dipole and quadrupole type illumination modes, it has been proposed to use spatial filters, that is opaque plates with apertures located where the poles are desired, as well as arrangements with movable bundles of optical fibres. Using spatial filters is undesirable because the resulting loss of radiation reduces the throughput of the apparatus and hence increases its cost of ownership. Arrangements with bundles of optical fibres are complex and inflexible. It has therefore been proposed to use an optical element, such as for example a diffractive or refractive optical element, to form the desired intensity distribution in the pupil plane. See, for example, European patent applications EP 0 949 541 A and EP 1 109 067 A. These documents describe, inter alia, diffractive optical elements in which different regions may have different effects, e.g. forming quadrupole or conventional illumination modes so that mixed or “soft” illumination modes can be created. Diffractive optical elements are currently made by etching different patterns into different parts of the surface of a quartz or CaF₂ substrate.

A diffractive optical element offers freedom in determining the intensity distribution in the pupil plane and thus, in theory, would allow the use of an illumination mode giving optimum results, i.e. largest process window, for a given mask pattern. However, the optimum illumination differs from pattern to pattern so that to use optimum illumination settings would require a custom-built diffractive optical element for each pattern to be illuminated. However, in practice it takes many weeks to manufacture a diffractive optical element so that it is impractical in most cases. Thus, a device manufacturer will instead have a collection of diffractive optical elements suitable for different types of pattern and select the one closest to optimum for a given mask pattern to be imaged. In addition, the combination of diffractive optical elements with zoom and axicon optics allows for a large flexibility in pupil shape with respect to σ_{outer/inner} that can be created using a single diffractive optical element.

In certain circumstances it is desirable for the projection beam to be polarized. The necessary polarization can be achieved by insertion of polarizing elements into the beam. If the same polarization is required across the whole pupil (as is the case for X, Y, dipoles and small conventional illumination (small σₒᵤₜₑᵣ), these polarizing elements can be placed anywhere in the illumination system, as long as the optics downstream of the polarizing elements (and if the elements are rotators, upstream of the polarizing elements) preserve the polarization. In some cases it is required that different areas of the pupil have different polarization directions. In order to achieve this the polarization must be effected in the pupil plane, requiring expensive and bulky polarizing elements. Thus the polarizing elements, especially for sources providing distributions other than X, Y dipoles or small σₒᵤₜₑᵣ, need to be very large. The handlers required for such plates are also large.

Many illumination systems include the use of an integrator rod, typically formed from quartz, which guides radiation out of the illumination system. However, such a quartz rod destroys the polarization of the radiation. Thus any polarization introduced into the projection beam before it enters the integrator rod will be lost. A polarization filter located downstream of the rod must therefore be used to polarize the radiation, leading to a large loss in intensity.

Recent studies have shown that an integrator rod which maintains the polarization of the radiation is a realistic possibility. However, even an ideal rod does not preserve polarization far from the X or Y axis. Compensation for this degradation of polarization can be achieved by the insertion of a polarizing filter, which again results in a significant reduction in intensity.

### SUMMARY OF THE INVENTION

It is therefore an object of the present invention to provide a more compact method for providing a polarized projection beam. It is a further object to provide a polarized projection beam with reduced intensity loss.

In accordance with one aspect of the invention there is provided an optical element for effecting a desired change in incident radiation at a plane of an illumination system of a lithographic apparatus, the optical element including an array of cells manufactured as a single unit, each cell being arranged to redirect the incident radiation in a predetermined direction, and an array of polarizing regions, each polarizing region being associated with a corresponding cell, wherein substantially all of the cells arranged to redirect radiation in a first direction each have associated with them a polarizing region ensuring that the redirected radiation has a first polarization, so that substantially all of the radiation redirected in the first direction has the same polarization.

Preferably some of the cells are arranged to redirect radiation in the first direction, and others of the cells are arranged to redirect radiation in a second direction. Each cell arranged to redirect radiation in the second direction preferably has associated with it a polarizing region ensuring that the redirected radiation has a second polarization, so that substantially all of the radiation redirected in the second direction has the same polarization. Thus radiation can be directed in two or more directions, with the polarization in each direction being uniform (but different for the first and second directions).

In a particular embodiment the array of polarizing regions is formed from a layer of optically active material, the polarizing effect of each polarizing region being determined by the thickness of the optically active material in that region. The thickness in each region is preferably controlled by etching.

The array of cells may be manufactured directly on the layer of optically active material. Alternatively, the optically active layer may be formed separately and attached to the array of cells.

In a further embodiment, the polarizing regions may be manufactured as discrete elements and then assembled into a single structure.

In one embodiment, each cell comprises a substantially identical structure, and some of the cells are rotated compared to at least some of the other cells. Thus for example, some of the cells may redirect radiation into a first dipole with a first polarization, and others of the cells may redirect radiation into a second dipole rotated relative to the first and with a second polarization. Thus the radiation may be redirected into a polarized quadrupole.

The optical element is a preferably diffractive optical element.

Each polarizing region may be arranged to cause a rotation of the polarization state of the incident radiation. Alternatively or in addition, each polarizing region may be arranged to cause at least partial polarization of the incident radiation.

Illumination systems generally include integrator rods into which radiation is coupled. Recent developments have resulted in rods which maintain at least some of the polarization of radiation passing therethrough. However, even with the best rods available the transmission of Intensity in Preferred State of polarization (IPS) degrades away from the axes of the rod. Therefore in a preferred embodiment, the cells of the optical element are arranged to redirect the radiation so as to compensate for the non-uniform IPS transmission of the integrator rod. This may be achieved by the cells of the optical element being arranged to redirect a higher intensity of radiation towards regions of the integrator rod which have a low IPS transmission than towards regions of the rod which have a high IPS transmission. A polarizing filter may be located downstream of the integrator rod.

In accordance with another aspect of the invention there is provided an illumination system for a lithographic apparatus, including an optical element for redirecting and polarizing incident radiation, and an integrator rod into which the redirected and polarized radiation is transmitted, wherein the integrator rod has a non-uniform transmission of Intensity in Preferred State of polarization (IPS) across the cross section of the rod, and wherein the optical element is arranged to redirect the polarized radiation so as to compensate for the non-uniform IPS transmission of the rod.

In accordance with a further aspect of the present invention there is provided an illumination system for a lithographic apparatus, including an optical element for redirecting and polarizing incident radiation, and an integrator rod into which the redirected radiation is transmitted, wherein the polarization of radiation transmitted through the integrator rod is not maintained uniformly across the cross section of the rod, and wherein the optical element is arranged to condition the polarization of the re-directed radiation so as to compensate for the polarization non-uniformity of the rod.

In accordance with a further aspect of the present invention there is provided a lithographic apparatus including an illumination system configured to condition a radiation beam, a support constructed to support a patterning device, the patterning device being capable of imparting the radiation beam with a pattern in its cross-section to form a patterned radiation beam, a substrate table constructed to hold a substrate, and a projection system configured to project the patterned radiation beam onto a target portion of the substrate, wherein the illumination system comprises an optical element for effecting a desired change in incident radiation at a plane of an illumination system of a lithographic apparatus, the optical element including an array of cells manufactured as a single unit, each cell being arranged to redirect the incident radiation in a predetermined direction, and an array of polarizing regions, each polarizing region being associated with a corresponding cell, wherein substantially all of the cells arranged to redirect radiation in a first direction each have associated with them a polarizing region ensuring that the redirected radiation has a first polarization, so that substantially all of the radiation redirected in the first direction has the same polarization.

In accordance with a yet further aspect of the present invention there is provided a method of conditioning a radiation beam in a lithographic apparatus, the method including redirecting and polarizing the radiation beam by passing it through an optical element, the optical element including an array of cells for redirecting radiation, and an array of polarizing regions, each polarizing region being associated with a corresponding cell, wherein substantially all of the cells which redirect radiation in a first direction each have associated with them a polarizing region ensuring that the redirected radiation has a first polarization, so that substantially all of the radiation redirected in the first direction has the same polarization.

In accordance with a further aspect of the present invention there is provided a method of conditioning a radiation beam in a lithographic apparatus, the method including redirecting and polarizing the radiation beam by passing it through an optical element, and transmitting the redirected radiation through an integrator rod which has a non-uniform transmission of Intensity in Preferred State of polarization (IPS) across the cross section of the rod, wherein the optical element redirects the radiation so as to compensate for the non-uniform IPS transmission of the integrator rod.

In accordance with another aspect of the present invention there is provided a method of conditioning a radiation beam in a lithographic apparatus, the method including redirecting and polarizing the radiation beam by passing it through an optical element, and transmitting the redirected radiation through an integrator rod which does not uniformly maintain the polarization of the radiation passing through the rod, wherein the optical element conditions the polarization of the re-directed radiation so as to compensate for the non-uniform polarization maintenance of the integrator rod.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIG. 2 is an illustration of part of the illumination system of the apparatus of FIG. 1;

FIG. 3A is a plan view of a diffractive optical component according to an embodiment of the invention;

FIG. 3B is a plan view of an array of polarizing regions for use in the optical component shown in FIG. 3A;

FIG. 3C is a plan view of the diffractive optical component of FIG. 3A and the polarizing regions of FIG. 3B superimposed on one another;

FIG. 3D is a view of a pupil plane following redirection of radiation by the optical component of FIG. 3C;

FIG. 4A is a side view of one embodiment of the optical component of FIG. 3C;

FIG. 4B is a side view of another embodiment of the optical component of FIG. 3C;

FIG. 4C is a side view of a further embodiment of the optical component of FIG. 3C;

FIG. 5A is a plan view of a diffractive optical component according to another embodiment of the invention;

FIG. 5B is a plan view of an array of polarizing regions for use in the optical component shown in FIG. 5A;

FIG. 5C is a plan view of the diffractive optical component of FIG. 5A and the polarizing regions of FIG. 5B superimposed on one another;

FIG. 5D is a view of a pupil plane following redirection of radiation by the optical component of FIG. 5C; and

FIG. 6 is a view of a pupil plane showing the regions into which radiation may be redirected by an optical element in accordance with the invention.

### DETAILED DESCRIPTION OF THE PREFERRED EMBODIMENT

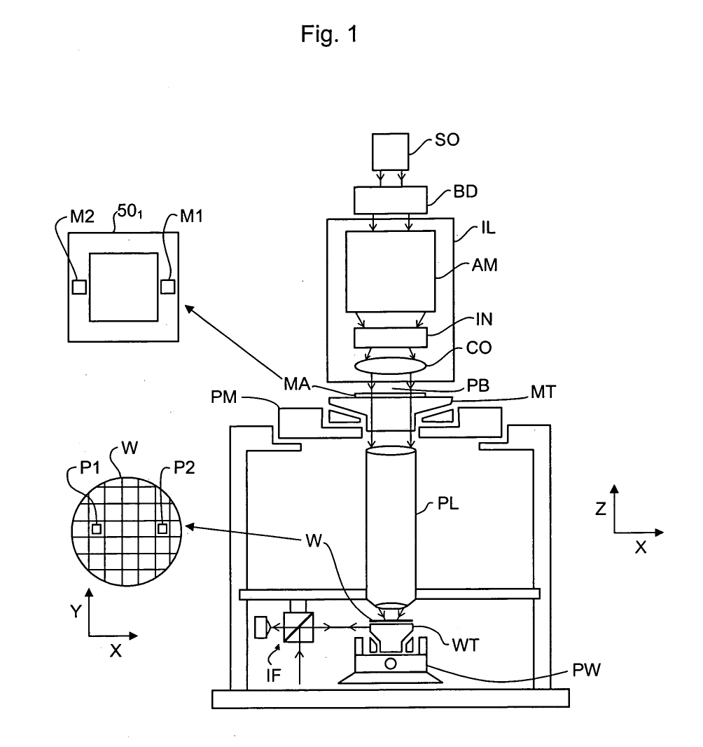

FIG. 1 schematically depicts a lithographic apparatus according to one embodiment of the invention. The apparatus includes:
an illumination system (illuminator) IL configured to condition a radiation beam B (e.g. UV radiation or);
a support structure (e.g. a mask table) MT constructed to support a patterning device (e.g. a mask) MA and connected to a first positioner PM configured to accurately position the patterning device in accordance with certain parameters;
a substrate table (e.g. a wafer table) WT constructed to hold a substrate (e.g. a resist-coated wafer) W and connected to a second positioner PW configured to accurately position the substrate in accordance with certain parameters; and
a projection system (e.g. a refractive projection lens system) PS configured to project a pattern imparted to the radiation beam B by patterning device MA onto a target portion C (e.g. comprising one or more dies) of the substrate W.

The illumination system may include various types of optical components, such as refractive, reflective, magnetic, electromagnetic, electrostatic or other types of optical components, or any combination thereof, for directing, shaping, or controlling radiation.

The support structure supports, i.e. bears the weight of, the patterning device. It holds the patterning device in a manner that depends on the orientation of the patterning device, the design of the lithographic apparatus, and other conditions, such as for example whether or not the patterning device is held in a vacuum environment. The support structure can use mechanical, vacuum, electrostatic or other clamping techniques to hold the patterning device. The support structure may be a frame or a table, for example, which may be fixed or movable as required. The support structure may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g. employing a transmissive mask). Alternatively, the apparatus may be of a reflective type (e.g. employing a programmable mirror array of a type as referred to above, or employing a reflective mask).

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

The lithographic apparatus may also be of a type wherein at least a portion of the substrate may be covered by a liquid having a relatively high refractive index, e.g. water, so as to fill a space between the projection system and the substrate. An immersion liquid may also be applied to other spaces in the lithographic apparatus, for example, between the mask and the projection system. Immersion techniques are well known in the art for increasing the numerical aperture of projection systems. The term “immersion” as used herein does not mean that a structure, such as a substrate, must be submerged in liquid, but rather only means that liquid is located between the projection system and the substrate during exposure.

Referring to FIG. 1, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD comprising, for example, suitable directing mirrors and/or a beam expander. In other cases the source may be an integral part of the lithographic apparatus, for example when the source is a mercury lamp. The source SO and the illuminator IL, together with the beam delivery system BD if required, may be referred to as a radiation system.

The illuminator IL comprises an adjuster or optical device (not shown in FIG. 1) for adjusting the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may comprise various other components, such as an integrator IN and a condenser CO. The illuminator may be used to condition the radiation beam, to have a desired uniformity and intensity distribution in its cross-section, as described in more detail below.

The radiation beam B is incident on the patterning device (e.g., mask MA), which is held on the support structure (e.g., mask table MT), and is patterned by the patterning device. Having traversed the mask MA, the radiation beam B passes through the projection system PS, which focuses the beam onto a target portion C of the substrate W. With the aid of the second positioner PW and position sensor IF (e.g. an interferometric device, linear encoder or capacitive sensor), the substrate table WT can be moved accurately, e.g. so as to position different target portions C in the path of the radiation beam B. Similarly, the first positioner PM and another position sensor (which is not explicitly depicted in FIG. 1) can be used to accurately position the mask MA with respect to the path of the radiation beam B, e.g. after mechanical retrieval from a mask library, or during a scan. In general, movement of the mask table MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the mask table MT may be connected to a short-stroke actuator only, or may be fixed. Mask MA and substrate W may be aligned using mask alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the mask MA, the mask alignment marks may be located between the dies.

The depicted apparatus could be used in at least one of the following modes:

1. In step mode, the mask table MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the mask table MT and the substrate table WT are scanned synchronously while a pattern imparted to the radiation beam is projected onto a target portion C (i.e. a single dynamic exposure). The velocity and direction of the substrate table WT relative to the mask table MT may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

3. In another mode, the mask table MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

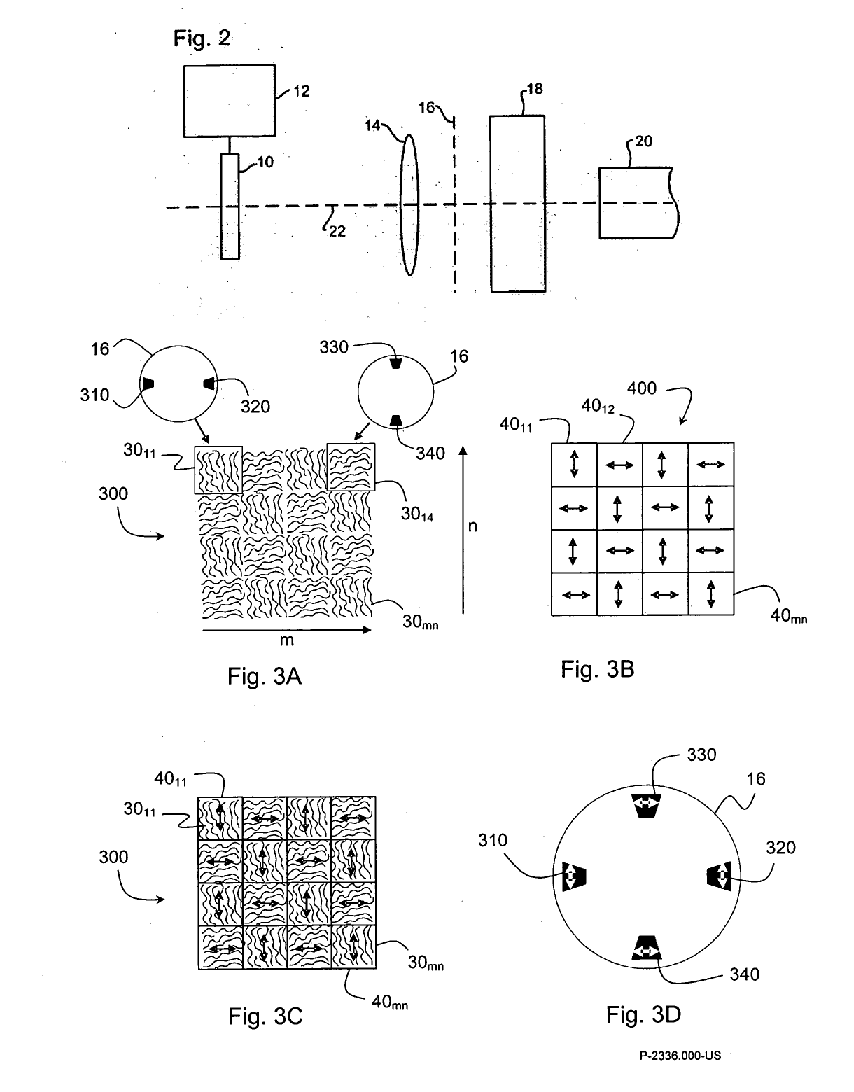

An embodiment of an illuminator according to the invention is shown in FIG. 2. It comprises an optical element 10 in the beam path 22 and an optical element exchanger 12 having access to other optical elements that can be substituted for optical element 10 in the beam path. The exchanger 12 may comprise any suitable device constructed and arranged to insert and remove the optical elements from the beam path, such as a carousel or rotatable disc provided with several optical elements and controllable to position a selected one of the optical elements in the beam path, or a “slide-in-slide-out” mechanism, as employed in a photographic slide projector, for example.

Radiation passing through the optical element 10 is condensed by a single lens 14 to produce a spatial intensity distribution at a pupil plane 16. In an alternative embodiment, the lens 14 is compound, but all its components are fixed, as opposed to the situation in a zoom-axicon, which can also be used in the invention. The pupil plane is located at the back focal plane of lens 14. The choice of optical element 10 determines the angular intensity distribution (i.e. illumination setting or mode) of the illuminator. Each exchangeable optical element 10 defines a particular intensity distribution at pupil plane 16, which in the case of, for example, an annular ring shape can be parameterised by an inner and outer radius.

In this embodiment, the single fixed lens 14 and the plurality of optical elements 10 replace the various (movable) lenses and the two complementary conical components of a zoom-axicon module. After the lens 14, the radiation is coupled by a coupling lens 18 into an integrator rod 20 (or fly's eye lens, for example). The axial location of coupling lens 18 is chosen such that its front focal plane substantially coincides with the pupil plane 16. This embodiment, in which an optical element is used to define completely the intensity distribution at the pupil plane, has no negative impact on performance, as indicated by projection beam characteristics such as uniformity, telecentricity and intensity distribution at the entrance side of integrator rod 20.

FIG. 3A is a plan view of an optical element 300, which may be used as one of the optical elements 10 shown in FIG. 2. The optical element 300 is formed as an array of m×n cells 30₁₁ to 30ₘₙ, each directing incident radiation into a range of angles in the pupil plane 16. For example, the top left cell 30₁₁ directs radiation to the regions 310, 320 in the pupil plane 16. In a preferred embodiment, each cell is approximate 1×1 mm in size, but it will be appreciated that other sizes may be used.

In the embodiment shown in FIG. 3A, all of the cells 30₁₁ to 30ₘₙ are identical, but arranged with alternating orientations. Every other cell 30₁₁, 30₃₁, 30₂₂ . . . is arranged at a first orientation and directs radiation to form a first dipole in the regions 310, 320. The remaining cells 30₁₂, 30₁₄, 30₂₁ . . . are arranged at a second orientation and direct radiation to form a second dipole at 90° to the first by directing radiation to regions 330, 340. The overall effect of the element is thus to direct radiation to both dipoles simultaneously to form a quadrupole.

The optical element 300 also comprises a polarizing layer 400 which underlies the diffractive cells 30₁₁ to 30ₘₙ, as shown in FIG. 3B. The polarizing layer 400 is formed as an array of polarizing areas 40₁₁ to 40ₘₙ, each of which corresponds to a diffractive cell 30₁₁-30ₘₙ. In the embodiment shown, the polarization of each area is at 90° to each adjacent area, so that all cells 30₁₁, 30₁₃, 30₂₂ . . . at a first orientation are associated with a corresponding polarizing area 40₁₁, 40₁₃, 40₂₂ . . . providing a first polarization, and the remaining cells 30₁₂, 30₁₄, 30₂₁ . . . at the second orientation are associated with corresponding polarizing areas 40₁₂, 40₁₄, 40₂₁ . . . providing a second polarization.

The polarizing areas 40₁₁ to 40ₘₙ may be polarization changing components such as half lambda plates. In this case the radiation beam should be polarized before it reaches the optical element 300. The polarizing areas will then rotate the radiation by differing amounts to provide the necessary polarization for each area. If the radiation beam is unpolarized, the polarizing areas may be polarizers rather than retarder plates.

FIG. 3C is a plan view of the optical element 300, with the polarization produced by the polarizing areas 40₁₁ to 40ₘₙ superimposed on the diffractive cells 30₁₁ to 30ₘₙ. The effect of this is shown in FIG. 3D, which shows the pupil plane 16. All the cells 30₁₁, 30₁₃, 30₂₂ . . . at the first orientation redirect radiation to the first dipole regions 310, 320 of the pupil plane 16 with a first polarization, and all the cells 30₁₂, 30₁₄, 30₂₁ . . . at the second orientation redirect radiation to the second dipole regions 330, 340 of the pupil plane 16 with a second polarization. The result is radiation in a polarized C-quadrupole.

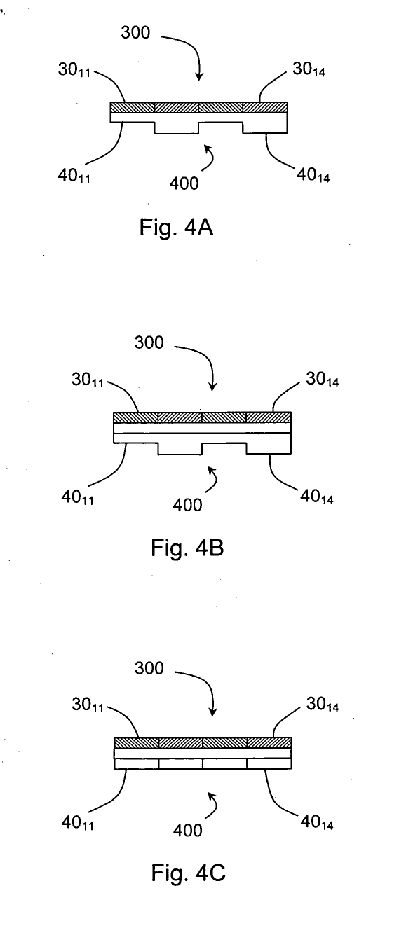

FIG. 4A is a cross section through one row of one embodiment of the optical element 300 and polarizing layer 400. In this embodiment the optical element 300 is manufactured from optically active material, and the back of this material is etched to form different polarizing areas 40₁₁ to 40ₘₙ. The different thicknesses of the optically active material provide the different polarization of the polarizing areas 40₁₁ to 40ₘₙ.

FIG. 4B is a cross section through one row of another embodiment of the optical element 300 and polarizing layer 400. In this embodiment the polarizing layer 400 is manufactured separately and attached to the back of the optical element 300.

FIG. 4C is a cross section through one row of a further embodiment of the optical element 300 and polarizing layer 400. In this embodiment the polarizing areas 40₁₁ to 40ₘₙ of the polarizing layer 400 are a set of discrete units manufactured separately and then assembled into a single structure, rather than forming the polarizing layer monolithically.

Thus it will be appreciated that the large polarizing elements previously required may be replaced by the small polarizing areas associated with or included in the optical element 300. A typical pupil plane 16 has a diameter of approximately 100 mm, so prior art polarizing elements would have generally been required to be of this size. The optical element 300 is placed at the plane 10 in which the radiation enters the illuminator (as shown in FIG. 2) and is typically of the order of 30×30 mm. The need for bulky and cumbersome polarizing elements has thus been removed.

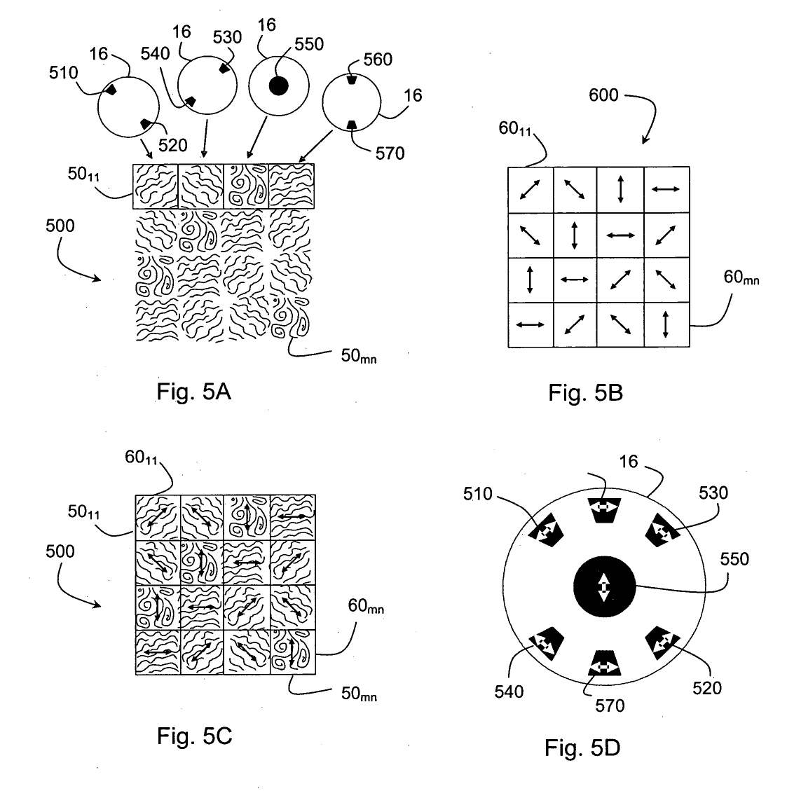

FIG. 5A is a plan view of another embodiment of an optical element 500, similar to the optical element 300 shown in FIGS. 3 and 4 for use as one of the optical elements 10 shown in FIG. 2. The optical element 500 is again formed as an array of m×n cells 50₁₁ to 50ₘₙ, each directing incident radiation into a range of angles in the pupil plane 16. In this embodiment there are four different types of cell redirecting radiation. The top left cell 50₁₁ directs radiation to regions 510, 520 of the pupil plane 16 to form a dipole. The next cell along 50₁₂ directs radiation to a second dipole encompassing regions 530, 540 of the pupil plane. The third cell 50₁₃ directs radiation to the central region 550 of the pupil plane 16. The fourth cell directs radiation to a third dipole 560, 570 in the pupil plane 16. The cells 50₂₁ to 50₂₄ in the next row are identical, but offset from the equivalent cells in the first row (so that 50₂₁ corresponds to 50₁₂, 50₂₂ to 50₁₃, 50₂₃ to 50₁₄, 50₂₄ to 50₁₁), and the each subsequent row is also offset from the previous row. The overall effect of the element is thus to direct radiation to all three dipoles 510, 520, 530, 540, 560, 570 and the central region 550 of the pupil plane simultaneously. It will be appreciated that the optical element 500 could be designed to produce any desired pattern in the pupil plane 16.

As in the previous embodiment, a polarizing layer 600, formed as an array of polarizing areas 60₁₁ to 60ₘₙ, underlies the diffractive cells 50₁₁ to 50ₘₙ, as shown in FIG. 5B. In this embodiment the polarization of the first two areas 60₁₁, 60₁₂ are at 90° to one another, and the polarization of the next two areas 60₁₃, 60₁₄ are also 90° apart, but offset by 45° from the first two areas 60₁₁, 60₁₂. The rows are again identical but offset, so that each of the cells 50₁₁ to 50ₘₙ which directs radiation to a particular region of the pupil plane 16 is associated with a polarizing are 60₁₁ to 60ₘₙ with the same direction of polarization. For example, as shown in a superimposed version in FIG. 5C, the cells 50₁₃, 50₂₂, 50₃₁, 50₄₄ which direct radiation to the central region 550 of the pupil plane 16 are all associated with vertical polarizing regions 60₁₃, 60₂₂, 60₃₁, 60₄₄.

Thus the result of the optical element 500 is to produce radiation redirected into a customised pattern, where each region has a specific polarization, as shown in FIG. 5D. The polarizing layer 600 is preferably formed from a layer of optically active material etched so that each polarizing region has a predetermined thickness, in a similar manner to that shown in FIGS. 4A and 4B.

Referring again to FIG. 2, it will be noted that the radiation is coupled by the coupling lens 18 into the integrator rod 20. Integrator rods have become available which partially preserve the polarization of the radiation as it passes through them. However, even an ideal rod does not preserve linear polarization uniformly.

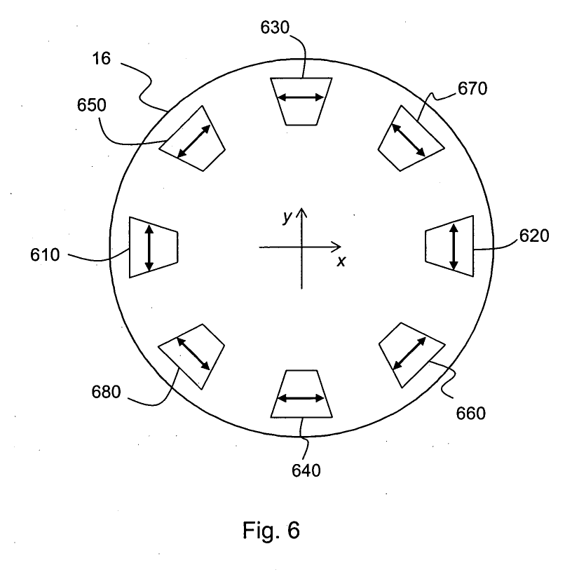

FIG. 6 is a view of the pupil plane 16 into which radiation has been directed by an exemplary optical element (not shown) similar to the elements 300, 500 described above with reference to FIGS. 3, 4 and 5. The radiation has been directed into four regions 610, 620, 630, 640 to form a polarized C-quad. One dipole 610, 620 is formed on the x-axis of the plane and the other dipole 630, 640 is formed on the y-axis of the plane. In addition, radiation has also been directed into four further regions 650, 660, 670, 680. The polarization of radiation in each region is shown in the figure.

When radiation with this distribution passes through the integrator rod 20, the transmitted Intensity in a Preferred State of polarization (IPS) is not uniform across the cross section of the rod. The transmitted IPS is highest near the x and y-axes of the rod, and lowest between them. In other words, the polarization of radiation in the regions 610, 620, 630, 640 of the dipoles which are near the x and y-axes is maintained, but the polarization of radiation in the regions 650, 660, 670, 680 away from the x and y-axes is reduced. The overall intensity of radiation passing through the rod is not affected, but the IPS of the radiation in the regions away from the x and y-axes is reduced.

Once the radiation has exited the integrator rod it may be passed through polarization filters which block radiation having a polarization other than the intended polarization. The result of the inhomogeneous IPS transmission of the rod is that, following filtering, the actual intensity of radiation on the x and y-axes (i.e. in the axial regions 610, 620, 630, 640) is higher than the intensity in the off-axial regions 650, 660, 670, 680 away from the x and y-axes.

This makes it possible to compensate for the inhomogeneous IPS transmission of the integrator rod. The optical element 300 is designed so that a higher intensity of radiation is transmitted to the off-axial regions 650, 660, 670, 680 than to the axial regions 610, 620, 630 640. The higher intensity in the off-axial regions compensates for the additional attenuation when the radiation passes through a polarization filter after it has passed through the rod.

This can be illustrated by a simple example. An exemplary integrator rod might transmit radiation with 100% IPS in the regions 610, 620, 630 640 near the x and y-axes, but with 80% IPS in the off-axial regions 650, 660, 670, 680. Suppose radiation is coupled into the integrator rod so that the intensity is uniform across all of the regions 610 to 680. When such radiation exits the integrator rod, the radiation in the axial regions 610, 620, 630 640 will have a 100% IPS, but the radiation in the off-axial regions 650, 660, 670, 680 will only have 80% IPS. At this stage the intensity across each region 610-680 is still uniform. The radiation then passes through a polarization filter which only allows radiation with the correct polarization direction to pass. After filtering, radiation in the off-axial regions 650, 660, 670, 680 has its intensity reduced to 80% of its former value, whereas the intensity of radiation in the axial regions 610, 620, 630 640 is unchanged.

The optical element therefore ensures that the intensity of radiation redirected to the off-axial regions 650, 660, 670, 680 is increased to 125% of the intensity of radiation in the axial regions 610, 620, 630 640. After passing through the rod the radiation in the off-axial regions 650, 660, 670, 680 has 125% of the total intensity of the radiation in the axial regions 610, 620, 630 640, but the IPS in the off-axial regions has been reduced to 80% of its former value, so the IPS of radiation in the off-axial regions is now 100% of the IPS of radiation in the axial regions. Following polarization filtering, the intensity of radiation in all regions is now uniform and correctly polarized.

There is also a further type of IPS degradation which may be introduced by the integrator rod 20, namely by changing the polarization of radiation passing through the rod by a known angle. If this type of degradation occurs, it can be compensated for by the optical element adjusting the polarization of radiation directed to particular regions of the pupil plane 16. This is straightforward to achieve when the optical element is formed from an array of cells having a corresponding array of polarizing regions, as described with reference to FIGS. 3 to 5 above. In other words, the radiation polarization is “pre-rotated” by the optical element 10 to compensate for the rotation in the integrator rod 20. This compensation does not require a polarization filter downstream of the integrator rod 20.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the invention in the context of optical lithography, it will be appreciated that the invention may be used in other applications, for example imprint lithography, and where the context allows, is not limited to optical lithography. In imprint lithography a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

The terms “radiation” and “beam” used herein encompass all types of electromagnetic radiation, including ultraviolet (UV) radiation (e.g. having a wavelength of or about 365, 248, 193, 157 or 126 nm) and extreme ultra-violet (EUV) radiation (e.g. having a wavelength in the range of 5-20 nm), as well as particle beams, such as ion beams or electron beams.

The term “lens”, where the context allows, may refer to any one or combination of various types of optical components, including refractive, reflective, magnetic, electromagnetic and electrostatic optical components.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g. semiconductor memory, magnetic or optical disk) having such a computer program stored therein.

The descriptions above are intended to be illustrative, not limiting. Thus, it will be apparent to one skilled in the art that modifications may be made to the invention as described without departing from the scope of the claims set out below.

1. An optical element for effecting a desired change in incident radiation at a plane of an illumination system of a lithographic apparatus, the optical element comprising:
an array of cells manufactured as a single unit, each cell being arranged to redirect the incident radiation in a predetermined direction; and
an array of polarizing regions, each polarizing region being associated with a corresponding cell;
wherein substantially all of the cells arranged to redirect radiation in a first direction each have associated with them a polarizing region ensuring that the redirected radiation has a first polarization, so that substantially all of the radiation redirected in the first direction has the same polarization.

2. The optical element of claim 1, wherein:
some of the cells are arranged to redirect radiation in the first direction, and others of the cells are arranged to redirect radiation in a second direction; and
substantially all of the cells arranged to redirect radiation in the second direction each have associated with them a polarizing region ensuring that the redirected radiation has a second polarization, so that substantially all of the radiation redirected in the second direction has the same polarization.

3. The optical element of claim 1, wherein the array of polarizing regions is formed from a layer of optically active material, the polarizing effect of each polarizing region being determined by the thickness of the optically active material in that region.

4. The optical element of claim 3, wherein one side of the layer is etched to control the thickness of material in each region.

5. The optical element of claim 3, wherein the array of cells is manufactured directly on the layer of optically active material.

6. The optical element of claim 1, wherein the polarizing regions are manufactured as a set of discrete units and assembled into a single structure.

7. The optical element of claim 1, wherein each cell comprises a substantially identical structure, and wherein at least some of the cells are rotated compared to at least some of the other cells.

8. The optical element of claim 1, wherein the cells are arranged so that radiation is redirected into a quadrupole.

9. The optical element of claim 8, wherein radiation in each dipole of the quadrupole is polarized in the same direction.

10. The optical element of claim 1, which element is a diffractive optical element.

11. The optical element of claim 1, wherein the illumination system comprises an integrator rod which transmits radiation but which has a non-uniform transmission of Intensity in Preferred State of polarization (IPS) across the cross section of the rod, and wherein the cells of the optical element are arranged to redirect the radiation so as to compensate for the non-uniform IPS transmission of the integrator rod.

12. The optical element of claim 11, wherein the cells of the optical element are arranged to redirect a higher intensity of radiation towards regions of the integrator rod which have a low IPS transmission than towards regions of the rod which have a high IPS transmission.

13. The optical element of claim 11, wherein each polarizing region is arranged to cause a rotation of the polarization state of the incident radiation.

14. The optical element of claim 11, wherein each polarizing region is arranged to cause at least partial polarization of the incident radiation.

15. An illumination system for a lithographic apparatus, comprising:
an optical element for redirecting and polarizing incident radiation; and
an integrator rod into which the redirected and polarized radiation is transmitted;
wherein the integrator rod has a non-uniform transmission of Intensity in Preferred State of polarization (IPS) across the cross section of the rod;
and wherein the optical element is arranged to redirect the polarized radiation so as to compensate for the non-uniform IPS transmission of the rod.

16. The illumination system of claim 15, wherein the optical element is arranged to redirect a higher intensity of radiation towards regions of the integrator rod which have a low IPS transmission than towards regions of the rod which have a high IPS transmission.

17. The illumination system of claim 15, further comprising a polarizing filter located downstream of the integrator rod.

18. The illumination system of claim 15, wherein the optical element comprises:
an array of cells manufactured as a single unit, each cell being arranged to redirect the incident radiation in a predetermined direction; and
an array of polarizing regions, each polarizing region being associated with a corresponding cell;
wherein substantially all of the cells arranged to redirect radiation in a first direction each have associated with them a polarizing region ensuring that the redirected radiation has a first polarization, so that substantially all of the radiation redirected in the first direction has the same polarization.

19. An illumination system for a lithographic apparatus, comprising:
an optical element for redirecting and polarizing incident radiation; and
an integrator rod into which the redirected radiation is transmitted;
wherein the polarization of radiation transmitted through the integrator rod is not maintained uniformly across the cross section of the rod;
and wherein the optical element is arranged to condition the polarization of the re-directed radiation so as to compensate for the non-uniformity of the rod.

20. A lithographic apparatus comprising:
an illumination system configured to condition a radiation beam;
a support constructed to support a patterning device, the patterning device being capable of imparting the radiation beam with a pattern in its cross-section to form a patterned radiation beam;
a substrate table constructed to hold a substrate; and
a projection system configured to project the patterned radiation beam onto a target portion of the substrate;
wherein the illumination system comprises an optical element for effecting a desired change in incident radiation at a plane of an illumination system of a lithographic apparatus, the optical element comprising:
an array of cells manufactured as a single unit, each cell being arranged to redirect the incident radiation in a predetermined direction; and
an array of polarizing regions, each polarizing region being associated with a corresponding cell;
wherein substantially all of the cells arranged to redirect radiation in a first direction each have associated with them a polarizing region ensuring that the redirected radiation has a first polarization, so that substantially all of the radiation redirected in the first direction has the same polarization.

21. A method of conditioning a radiation beam in a lithographic apparatus, the method comprising:
redirecting and polarizing the radiation beam by passing it through an optical element, the optical element comprising:
an array of cells for redirecting radiation; and
an array of polarizing regions, each polarizing region being associated with a corresponding cell;
wherein substantially all of the cells which redirect radiation in a first direction each have associated with them a polarizing region ensuring that the redirected radiation has a first polarization, so that substantially all of the radiation redirected in the first direction has the same polarization.

22. The method of claim 21, further comprising coupling the redirected radiation into an integrator rod which has a non-uniform transmission of Intensity in Preferred State of polarization (IPS) across the cross section of the rod;
wherein the cells of the optical element redirect the radiation so as to compensate for the non-uniform IPS transmission of the integrator rod.

23. A method of conditioning a radiation beam in a lithographic apparatus, the method comprising:
redirecting and polarizing the radiation beam by passing it through an optical element; and
transmitting the redirected radiation through an integrator rod which has a non-uniform transmission of Intensity in Preferred State of polarization (IPS) across the cross section of the rod;
wherein the optical element redirects the radiation so as to compensate for the non-uniform IPS transmission of the integrator rod.

24. The method of claim 23, wherein the optical element redirects a higher intensity of radiation towards regions of the integrator rod which have a low IPS transmission than towards regions of the rod which have a high IPS transmission.

25. A method of conditioning a radiation beam in a lithographic apparatus, the method comprising:
redirecting and polarizing the radiation beam by passing it through an optical element; and
transmitting the redirected radiation through an integrator rod which does not uniformly maintain the polarization of the radiation passing through the rod;
wherein the optical element conditions the polarization of the re-directed radiation so as to compensate for the non-uniform polarization maintenance of the integrator rod.
